(19) United States
(12) Patent Application Publication
(10) Pub. No.: US 2008/0218020 A1
(43) Pub. Date: Sep. 11, 2008

(54) Shaft assembly

(75) Inventor: Qi Zhu, Shanghai (CN)

Correspondence Address: DAVID AND RAYMOND PATENT FIRM, 108 N. YNEZ AVE., SUITE 128, MONTEREY PARK, CA, 91754, US

(73) Assignee: Hui Sun

(21) Appl. No.: 12/001,678

(22) Filed: Dec. 11, 2007

(30) Foreign Application Priority Data
Mar. 8, 2007 (CN) 200720067710.1
Sep. 7, 2007 (CN) 200720177077

(51) Int. Cl. H02K 5/16; F16C 3/00

(52) U.S. Cl. 310/90; 310/91

(57) ABSTRACT

A shaft assembly includes a rotatable shaft, an upper supporting frame having a bearing cavity, a lower supporting frame coupling with the upper supporting frame, a bearing assembly, and a shaft guider. The bearing assembly includes a first bearing rotor disposed in the bearing cavity to coaxially engage with the rotatable shaft and a second bearing rotor coaxially engaging with the rotatable shaft, wherein a circumferential size of the bearing cavity is larger than an outer diameter of the bearing module. The shaft guider is coupled between the first and second bearing rotors to retain a position of the bearing assembly with respect to the rotatable shaft, wherein the shaft guider has an outer diameter smaller than the circumferential size of the bearing cavity and an inner diameter smaller than an outer diameter of each of the first and second bearing rotors.

### BACKGROUND OF THE PRESENT INVENTION

1. Field of Invention

The present invention relates to a rotational transmission device, and more particularly to a shaft assembly with a rotational axis and bearing module for use in the power tool for power transmission.

2. Description of Related Arts

According to the mechanical theory, a shaft assembly generally comprises a transmission shaft for transmitting a mechanical power and a bearing module for enhancing the mechanical movement of the transmission shaft. Accordingly, the bearing module not only maintains the transmission shaft in position to precisely move along its axis but also reduces a friction between transmission shaft and the supporting frame. Generally speaking, there are two types of transmission shaft, wherein one type the transmission shaft produces a sliding movement at the supporting frame while another type of the transmission shaft produces a rotational movement at the supporting frame.

Accordingly, the bearing module generally comprises a ring shaped inner rotor, a ring shaped outer rotor, and a plurality of ball-shaped bearing elements disposed between the inner and outer rotors such that the inner rotor is smoothly rotated within the outer rotor via the bearing elements. For a mechanical use, the inner rotor is coupled with the transmission shaft to drive the transmission shaft to rotate. The outer rotor is coupled with the supporting frame. The bearing elements are spacedly retained between the inner and outer rotors via a retainer, wherein the retainer is adapted to keep the bearing elements in a spaced apart manner to evenly distribute the force between the inner and outer rotors, to prevent the bearing elements from being dropped between the inner and outer rotors, and to reduce a friction between the inner and outer rotors for enhancing the rotational movement of the inner rotor with respect to the outer rotor.

In order to enhance the strength of the bearing module with respect to the transmission shaft, two or more bearing modules are coupled with the transmission shaft in a serial manner. Accordingly, the bearing module can be assembled to the transmission shaft by molding or at one end of the transmission shaft.

After the bearing module is coupled with the transmission shaft, the size of the mounting slot of the supporting frame must be matched with the size of the bearing module for the bearing module fitting into the mounting slot. It is worth to mention that the size of the mounting slot will affect the service life span of the bearing module. In other words, the diameter of the mounting slot must be perfectly fitted for the diameter of the bearing module in order to minimize a clearance therebetween. Accordingly, when there is a gap formed between the bearing module and the inner wall of the mounting slot, the rotational movement of the transmission shaft will cause the bearing module to vibrate so as to create an unwanted vibration of the bearing module within the mounting slot and to create an abrasion and fatigue of the bearing module. In order to reduce the vibration of the bearing module and the noise thereof and to prolong the service life span of the bearing module, the size of the mounting slot must be precisely configured to match with the bearing module. However, it will substantially increase the manufacturing cost of the shaft assembly and will complicate the assembling operation of the shaft assembly, especially when the transmission shaft is extended in an off-center position. In addition, when the transmission shaft is needed to be replaced, the bearing module must be also replaced during the disassembling operation of the shaft assembly. As a result, such structural configuration of the shaft assembly is not suitable for mass production.

### SUMMARY OF THE PRESENT INVENTION

A main object of the present invention is to provide a shaft assembly to solve the above problems, wherein the shaft assembly provides a simple structural configuration for being assembled and provides a rigid configuration for supporting the rotatable shaft. In addition, the mounting cavity does not require the precise configuration for the bearing module disposing therein. Therefore, the shaft assembly is adapted to prolong the service life span of the bearing module to supportively enhance the rotational movement of the rotatable shaft.

Accordingly, in order to achieve the above object, the present invention provides a shaft assembly which comprises a rotatable shaft, a bearing assembly, a lower supporting frame, and an upper supporting frame having a bearing cavity. The bearing assembly is disposed in the bearing cavity and is securely enclosed by the lower supporting frame when the lower supporting frame is coupled with the upper supporting frame. The bearing assembly comprises a first bearing rotor disposed in the bearing cavity of the upper supporting frame and a second bearing rotor supported by the lower supporting frame, wherein the first and second bearing rotors are positioned space apart from each other and are coaxially coupled with the rotatable shaft for enhancing a rotational movement of the rotatable shaft. A ring-shaped shaft guider is coupled between the first and second bearing rotors to retain a position of the bearing assembly is with respect to the rotatable shaft. In other words, the shaft guider is supported at a gap between the first and second bearing rotors. In addition, the upper supporting frame further has an upper platform shoulder formed at an upper wall of the bearing cavity 31 to engage an outer rotor ring of the first bearing rotor.

Accordingly, an outer diameter of the shaft guider is smaller than a diameter of the bearing cavity of the upper supporting frame, wherein an inner diameter of the shaft guider is larger than an outer diameter of the inner rotor ring of the first bearing rotor. In other words, a circumferential size of the bearing cavity is larger than an outer diameter of the bearing module while an inner diameter of the shaft guider is smaller than an outer diameter of each of the first and second bearing rotors.

The bearing assembly is engaged with the rotatable shaft at an upper end portion thereof.

The rotatable shaft comprises a retention unit to prevent the rotatable shaft from being slid out of the bearing assembly. Accordingly, the rotatable shaft has a retention shoulder protruding radially and outwardly to supportively bias against the bottom surface of the second bearing rotor. A ring-shaped retention clip is coaxially mounted at the rotatable shaft at a position above the second bearing rotor to block the second bearing rotor from being moved along the rotatable shaft.

Accordingly, the lower supporting frame forms a cover of the upper supporting frame to enclose the bearing cavity thereof. The lower supporting frame is engaged with the upper supporting frame via a screw. In other words, when the lower supporting frame is engaged with the upper supporting frame to retain the bearing assembly in the bearing cavity, an upper side of the first bearing rotor is biased against the upper wall of the upper supporting frame while a bottom side of the second bearing rotor is biased against the bottom wall of the lower supporting frame.

The lower supporting frame further has a shaft slot and a lower platform shoulder to bias against the outer rotor ring of the second bearing rotor. In other words, when the lower supporting frame is engaged with the upper supporting frame, an upper portion of the rotatable shaft is extended to the bearing cavity while the lower portion of the rotatable shaft is extended through the shaft slot of the lower supporting frame.

Alternatively, the lower supporting frame can be formed in an arc shape to partially cover the bearing cavity when the lower supporting frame is engaged with the upper supporting frame via the screw. In other words, only a portion of the second bearing rotor is supported by the lower supporting frame.

Accordingly, the present invention provides a simple assembling structure of the shaft assembly, wherein the bearing module is adapted to easily dispose in the mounting cavity because the size of the bearing cavity is larger than the size of the bearing module. Therefore, the user is able to couple the bearing module with the upper supporting frame without any difficulty. In addition, the bearing module is retained between the upper and lower supporting frames to prevent the bearing module from being detached during operation. The shaft guider is coupled between the first and second bearing rotors of the bearing module to retain a position of the bearing assembly with respect to the rotatable shaft. In other words, the bearing module does not require to tightly couple with the bearing cavity because the shaft guider is adapted to retain the position of the bearing module to engage with the rotatable shaft. In addition, once the bearing module is assembled in position, the shaft guider is adapted to prevent the vibration of the bearing module from the rotational movement of the rotatable shaft so as to prolong the service life span of the bearing module.

Accordingly, the manufacturing process and cost of the present invention is significantly lower. In other words, the assembling operation of the shaft assembly of the present invention is extremely easy, wherein the manufacturing process of the present invention can be simplified to substantially reduce the manufacturing cost thereof, so as to enhance the practice use of the present invention while being cost effective.

The present invention has a compact size in light weight. The size of the rotatable shaft can be minimized to provide a high speed and precise rotational output with minimum abrasion. Thus, the structural configuration of the present invention is suitable for mass production and is adapted to provide a stable rotational output with less noise and vibration so as to enhance the productivity of the shaft assembly.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a shaft assembly according to a preferred embodiment of the present invention.

FIG. 2 illustrates an alternative mode of the shaft assembly according to the above preferred embodiment of the present invention.

### DETAILED DESCRIPTION OF THE PREFERRED EMBODIMENT

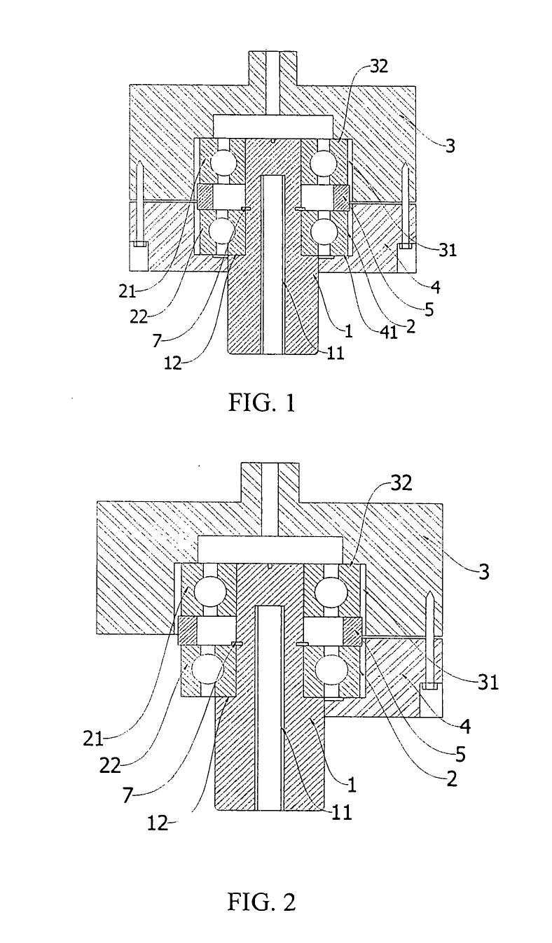

Referring to FIG. 1 of the drawings, a shaft assembly according to a preferred embodiment of the present invention is illustrated, wherein the shaft assembly comprises a rotatable shaft 1 having a circular cross section, a bearing module 2, a lower supporting frame 4 in which a lower portion of the rotatable shaft 1 is extended through the lower supporting frame 4, and an upper supporting frame 3 having a bearing cavity 31 in which an upper portion of the rotatable shaft 1 is extended within the bearing cavity 31 of the upper supporting frame 3. Accordingly, the bearing module 2, having an assemble structure, comprises a first bearing rotor 21 and a second bearing rotor 22 spacedly and coaxially coupling at the rotatable shaft 1. Each of the first and second bearing rotors 21, 22, having a ring shape, has an inner circumferential surface engaging with an outer circumferential surface of the rotatable shaft 1. In addition, each of the first and second bearing rotors 21, 22 has an outer rotor ring and an inner rotor ring coaxially and rotatably engaging with the outer rotor ring, wherein the inner surface of the inner rotor ring is engaged with the outer circumferential surface of the rotatable shaft 1. The upper supporting frame 3 further has an upper platform shoulder 32 formed at an upper wall of the bearing cavity 31 to engage an outer rotor ring of the first bearing rotor 21. A ring-shaped shaft guider 5 is coaxially positioned at the rotatable shaft 1 and is coupled between the first and second bearing rotors 21, 22. The shaft guider 5 preferably has a ring shape or has a hollow structure. The shaft guider 5, which is coaxially encircling with the rotatable shaft 1, has top and bottom sides biasing against a bottom side of the first bearing rotor 21 and a top side of the second bearing rotor 22 respectively. Accordingly, an outer diameter of the shaft guider 5 is smaller than a circumferential size of the bearing cavity 31 of the upper supporting frame 3. An inner diameter of the shaft guider 5 is larger than an outer diameter of the inner rotor ring of each of the first and second bearing rotors 21, 22.

As shown in FIG. 1, the first bearing rotor 21 is disposed in the bearing cavity 31 of the upper supporting frame 3 at a position that an upper side of the first bearing rotor 21 is biased against the upper platform shoulder 32 of the upper supporting frame 3, wherein a bottom side of the second bearing rotor 22 is biased against an inner surface of the lower supporting frame 4 to support the second bearing rotor 22 by the lower supporting frame 4 so as to retain the second bearing rotor 22 in position.

Accordingly, the first and second bearing rotors 21, 22 can be formed as one integrated unit or can be formed by a plurality of bearing units serially coupled with each other.

According to the preferred embodiment, the lower supporting frame 4 is securely coupled with the upper supporting frame 3 via screws that a bottom surface of the upper supporting frame 3 is biased against a top surface of the lower supporting frame 4. Therefore, the bearing module 2 is enclosed within the bearing cavity 31 after the lower supporting frame 4 is coupled with the upper supporting frame 3 to prevent the bearing module 2 from being detached during operation.

Accordingly, the lower supporting frame 4 can be formed as an enclosing cover to securely couple with the upper supporting frame 3 via the screws, wherein the second bearing rotor 22 is sat at a lower platform shoulder 41 as a seating portion of the lower supporting frame 4 at a position that a lower portion of the rotatable shaft 1 is extended through a shaft slot of the lower supporting frame 4.

It is worth to mention that the lower supporting frame 4 can be formed at different configuration that the bottom surface of the second bearing rotor 22 is partially supported on the lower supporting frame 4. In other words, the lower supporting frame 4 is formed in an arc shape to support the second bearing rotor 22, wherein the lower supporting frame 4 is then coupled with the upper supporting frame 3 via screws or the like as shown in FIG. 2. Therefore, the bearing cavity 31 is partially enclosed by the lower supporting frame 4 while the bearing module 2 is still retained in the bearing cavity 31 to prevent the bearing module 2 from being detached during operation.

According to the preferred embodiment, the rotatable shaft 1 further comprises a device for retaining the second bearing rotor 22 in position, wherein the rotatable shaft 1 has a retention shoulder 12 protruding radially and outwardly to supportively bias against the bottom surface of the second bearing rotor 22 for preventing the second bearing rotor 22 from being detached from an upper portion of the rotatable shaft 1.

A ring-shaped retention clip 7 is coaxially mounted at the rotatable shaft 1 at a position above the second bearing rotor 22 to block the second bearing rotor 22 from being moved along the rotatable shaft 1.

The rotatable shaft 1, having a tubular shape, further has a shaft channel with an inner threaded portion 11 for engaging with a driving component to be driven by the rotatable shaft 1.

Accordingly, the bearing cavity 31 of the upper supporting frame 3 can be made according to the actual use of the shaft assembly, wherein the bearing cavity 31 can be configured with an eccentric structure or concentric structure. Thus, the eccentric structure of the upper supporting frame 3 does not significantly increase difficulty of the manufacturing process thereof.

In order to assemble the shaft assembly of the present invention, the bearing module 2 does not need to fittingly dispose in the bearing cavity 31 of the upper supporting frame 3. Accordingly, the circumferential size of the bearing cavity 31 is larger than the outer diameter of the bearing module 2. The gap is formed between the outer circumferential surface of the bearing module 2 and the inner circumferential surface of the bearing cavity 31. In other words, the shaft assembly of the present invention does not require the bearing cavity 31 being precisely formed for fitting the bearing module 2 therein so as to reduce the manufacturing cost for making the precise dimension of the bearing cavity 31 with respect to the size of the bearing module 2. Thus, the assembling operation of the bearing module 2 will be substantially simplified by simply disposing the bearing module 2 in the bearing cavity 31 with the gap therebetween. In particularly, the gap between the outer circumferential surface of the bearing module 2 and the inner circumferential surface of the bearing cavity 31 will not be affect the rotational operation of the rotatable shaft 1 with respect to the bearing module 2. Therefore, by simply disposing the first bearing rotor 21 in the bearing cavity 31 of the upper supporting frame 3, the shaft guider 5 will automatically retain the position of the bearing module 2 with respect to the rotatable shaft 1 so as to prevent any unwanted lateral movement of the bearing module 2. Therefore, the assembling operation of the shaft assembly of the present invention is extremely easy, wherein the manufacturing process of the upper supporting frame 3 can be simplified to substantially reduce the manufacturing cost thereof, so as to enhance the practice use of the present invention while being cost effective.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shaft assembly, comprising:
a rotatable shaft;
an upper supporting frame having a bearing cavity, wherein an upper portion of said rotatable shaft is extended within said bearing cavity of said upper supporting frame;
a lower supporting frame coupling with said upper supporting frame wherein a lower portion of said rotatable shaft is extended through said lower supporting frame;
a bearing assembly, which is supported by said upper and lower supporting frames for enhancing a rotational movement of said rotatable shaft, comprising a first bearing rotor which is disposed in said bearing cavity and is coaxially coupled with said rotatable shaft, and a second bearing rotor which is coaxially coupled with said rotatable shaft and is positioned spaced apart from said first bearing rotor, wherein a circumferential size of said bearing cavity is larger than an outer diameter of said bearing module, wherein an upper side of said first bearing rotor is biased against an inner surface of said upper supporting frame while a bottom side of said second bearing rotor is biased against an inner surface of the lower supporting frame; and
a shaft guider coupling between said first and second bearing rotors to retain a position of said bearing assembly with respect to said rotatable shaft.

2. The shaft assembly, as recited in claim 1, wherein said shaft guider has a ring shape coaxially encircling with said rotatable shaft and top and bottom sides biasing against a bottom side of said first bearing rotor and a top side of said second bearing rotor respectively.

3. The shaft assembly, as recited in claim 1, wherein an outer diameter of said shaft guider is smaller than said circumferential size of said bearing cavity of said upper supporting frame.

4. The shaft assembly, as recited in claim 2, wherein an outer diameter of said shaft guider is smaller than said circumferential size of said bearing cavity of said upper supporting frame.

5. The shaft assembly, as recited in claim 2, wherein an inner diameter of said shaft guider is larger than an outer diameter of an inner rotor ring of each of said first and second bearing rotors.

6. The shaft assembly, as recited in claim 4, wherein an inner diameter of said shaft guider is larger than an outer diameter of an inner rotor ring of each of said first and second bearing rotors.

7. The shaft assembly, as recited in claim 1, wherein said lower supporting frame is securely coupled with said upper supporting frame that a bottom surface of said upper supporting frame is biased against a top surface of said lower supporting frame to enclose said bearing cavity.

8. The shaft assembly, as recited in claim 2, wherein said lower supporting frame is securely coupled with said upper supporting frame that a bottom surface of said upper supporting frame is biased against a top surface of said lower supporting frame to enclose said bearing cavity.

9. The shaft assembly, as recited in claim 6, wherein said lower supporting frame is securely coupled with said upper supporting frame that a bottom surface of said upper supporting frame is biased against a top surface of said lower supporting frame to enclose said bearing cavity.

10. The shaft assembly, as recited in claim 1, wherein said lower supporting frame, forming in an arc shape, is securely coupled with said upper supporting frame that said lower supporting frame is partially support said bottom side of said second bearing rotor to partially enclose said bearing cavity.

11. The shaft assembly, as recited in claim 2, wherein said lower supporting frame, forming in an arc shape, is securely coupled with said upper supporting frame that said lower supporting frame is partially support said bottom side of said second bearing rotor to partially enclose said bearing cavity.

12. The shaft assembly, as recited in claim 6, wherein said lower supporting frame, forming in an arc shape, is securely coupled with said upper supporting frame that said lower supporting frame is partially support said bottom side of said second bearing rotor to partially enclose said bearing cavity.

13. The shaft assembly, as recited in claim 1, wherein said rotatable shaft further has a retention shoulder protruding radially and outwardly to supportively bias against said bottom side of said second bearing rotor.

14. The shaft assembly, as recited in claim 9, wherein said rotatable shaft further has a retention shoulder protruding radially and outwardly to supportively bias against said bottom side of said second bearing rotor.

15. The shaft assembly, as recited in claim 12, wherein said rotatable shaft further has a retention shoulder protruding radially and outwardly to supportively bias against said bottom side of said second bearing rotor.

16. The shaft assembly, as recited in claim 1, further comprising a ring-shaped retention clip coaxially mounted at said rotatable shaft at a position above said second bearing rotor to block said second bearing rotor from being moved along said rotatable shaft.

17. The shaft assembly, as recited in claim 14, further comprising a ring-shaped retention clip coaxially mounted at said rotatable shaft at a position above said second bearing rotor to block said second bearing rotor from being moved along said rotatable shaft.

18. The shaft assembly, as recited in claim 15, further comprising a ring-shaped retention clip coaxially mounted at said rotatable shaft at a position above said second bearing rotor to block said second bearing rotor from being moved along said rotatable shaft.

19. The shaft assembly, as recited in claim 17, wherein said rotatable shaft, having a tubular shape, further has a shaft channel with an inner threaded portion.

20. The shaft assembly, as recited in claim 18, wherein said rotatable shaft, having a tubular shape, further has a shaft channel with an inner threaded portion.
